(19) United States
(12) Patent Application Publication
(10) Pub. No.: US 2025/0100866 A1
(43) Pub. Date: Mar. 27, 2025

(54) FLUID LINE MONITORING AND CONTROL ASSEMBLY

(71) Applicant: Paul McGrane, Sioux Falls, SD (US)

(72) Inventor: Paul McGrane, Sioux Falls, SD (US)

(21) Appl. No.: 18/977,392

(22) Filed: Dec. 11, 2024

Related U.S. Application Data
(63) Continuation-in-part of application No. 17/537,604, filed on Nov. 30, 2021, now Pat. No. 12,187,595.

(51) Int. Cl. B67D 1/14; B67D 1/08; B67D 1/12

(52) U.S. Cl. CPC B67D 1/1422; B67D 1/0888; B67D 1/1202

(57) ABSTRACT

A fluid line monitoring and control assembly for detecting foaming and terminating flow in a beverage line includes a valve and a flow meter, which are insertable in-line with a conduit connecting a storage vessel to a dispensing tap, and a controller. The valve and the flow meter both are positioned proximate to the storage vessel. The valve can close the conduit to prevent flow of a beverage therethrough. The flow meter generates a voltage signal with flow of the beverage therethrough and sends the voltage signal to a controller. The controller is programmed with an algorithm that enables the controller to evaluate the voltage signal for a change in one or more of magnitude, stability, and frequency to determine if the beverage has changed between a liquid state and a foam state, whereupon the controller actuates the valve to close the beverage line.

### CROSS-REFERENCE TO RELATED APPLICATIONS

This application is a Continuation in Part of patent application Ser. No. 17/537,604 filed Nov. 30, 2021.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to monitoring and control assemblies and more particularly pertains to a new monitoring and control assembly for detecting foaming and terminating flow in a beverage line. The present discloses a control assembly including a flow meter and valve, wherein a change in an output signal from the flow meter is correlated to a change of state of a beverage in a beverage line from a liquid state to a foam state, and wherein the change of state prompts a controller to actuate the valve to close the beverage line.

### (2) Description of Related Art including information disclosed under 37 CFR 1.97 and 1.98.

The prior art relates to monitoring and control assemblies, and more particularly, monitoring and control assemblies for beverage lines, such as beer lines running between kegs or brite tanks and dispensing taps. Related prior art may comprise sensors that detect foam formation in vessels, such as tanks, reactors, and the like. Additional prior art may comprise optical sensors used to detect foam in lines. Still more prior art may comprise mechanical Foam-on-Beer (FOB) detectors with automatic line closing elements. While flow meters of various configurations are disclosed in the prior art, they are enabled only for generating an output signal that is integrated by a controller to determine a volume of beverage that has been dispensed. What is lacking in the prior art is a control assembly combining a flow meter, a valve, and a controller, wherein the controller has been programmed with an algorithm to evaluate the output signal for a change in one or more of magnitude, stability, and frequency to determine if the beverage passing through the conduit has changed between a liquid state and a foam state, whereupon the change of state prompts a controller to actuate the valve to close the beverage line.

### BRIEF SUMMARY OF THE INVENTION

An embodiment of the disclosure meets the needs presented above by generally comprising a controller, a valve, a flow meter, and a power supply unit, which is operationally engaged to the controller, the valve, and the flow meter. The valve and the flow meter are communicatively engaged to the controller and are configured to be insertable in-line with a conduit connecting a storage vessel to a dispensing tap, such as a beer line connecting a keg or brite tank to a dispensing tap. The flow meter and the valve are positioned proximate to the storage vessel and the valve is configured to selectively close the conduit to prevent flow of a beverage through the conduit.

The flow meter is configured to generate an output signal based on flow of the beverage through the conduit and to send the output signal to the controller. As in the prior art, the controller is programmed to integrate the output signal to determine a volume of the beverage that has passed through the conduit.

Differentiating the present invention from the prior art, the controller also is programmed with an algorithm that enables the controller to evaluate the output signal for a change in one or more of magnitude, stability, and frequency to determine if the beverage passing through the conduit has changed between a liquid state and a foam state. The change of state prompts the controller to actuate the valve to close the beverage line.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a block diagram of a fluid line monitoring and control assembly according to an embodiment of the disclosure.

FIG. 2 is an open view of an embodiment of the disclosure.

FIG. 3 is an in-use of an embodiment of the disclosure.

FIG. 4 is an open view of an embodiment of the disclosure.

FIG. 5 is an open view of an embodiment of the disclosure.

FIG. 6 an in-use view of an embodiment of the disclosure.

FIG. 7 is an in-use view of an embodiment of the disclosure.

FIG. 8 is chart of voltage output generated by an embodiment of the disclosure.

### DETAILED DESCRIPTION OF THE INVENTION

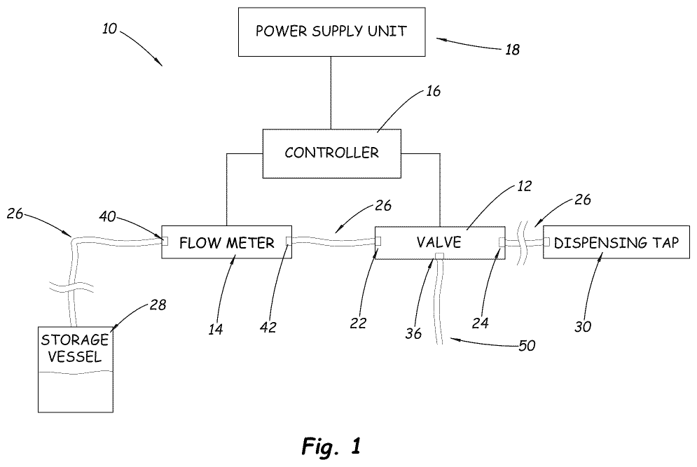

With reference now to the drawings, and in particular to FIGS. 1 through 8 thereof, a new monitoring and control assembly embodying the principles and concepts of an embodiment of the disclosure and generally designated by the reference numeral 10 will be described.

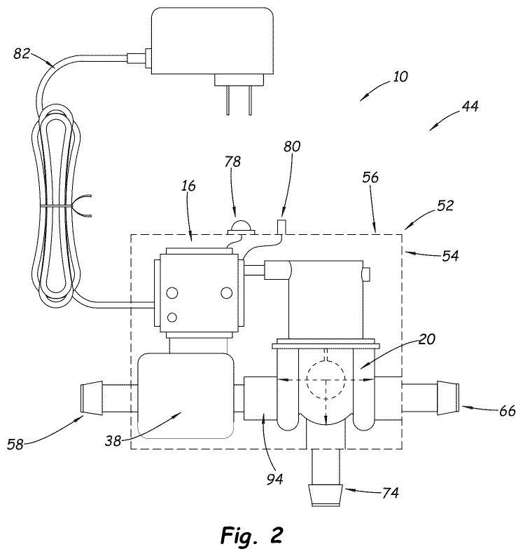

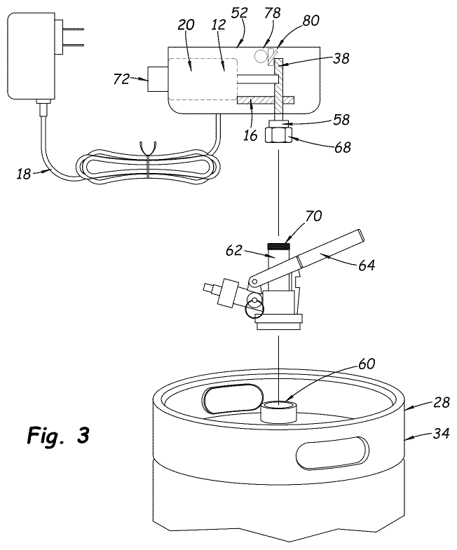

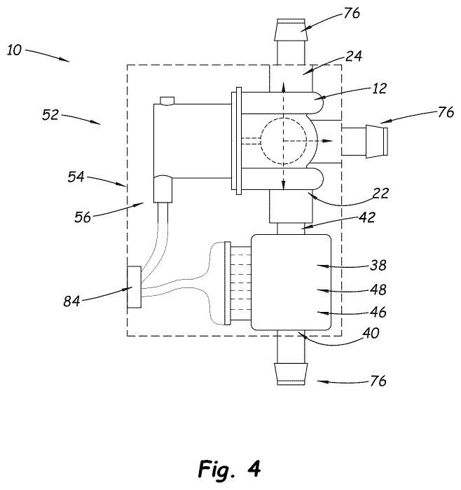

As best illustrated in FIGS. 1 through 8, the fluid line monitoring and control assembly 10 generally comprises a valve 12, a flow meter 14, a controller 16, and a power supply unit 18. The valve 12 comprises a solenoid valve 20, as is shown in FIGS. 2, 4, and 5, or other type of actuated on-off valve, such as, but not limited to, pneumatic valves, hydraulic valves, electric valves, spring valves, or the like. The valve 12, most typically is of the normally open type, comprises an inlet port 22 and an outlet port 24 and thus is configured to be insertable in-line with a conduit 26 connecting a storage vessel 28 to a dispensing tap 30 with the valve 12 being positioned proximate to the storage vessel 28. The conduit 26 may comprise a beer line 32 that is being used to connect the storage vessel 28, such as a keg 34, brite tank (not shown), or the like, to the dispensing tap 30. The valve 12 is configured to selectively terminate flow of a beverage through the conduit 26. As is shown in FIGS. 3 and 4, the valve 12, being three-way, also comprises an exhaust port 36 so that the valve 12 is configured to be selectively connectable to an exhaust line 50.

The flow meter 14 comprises a thermal mass flow meter 38, a mechanical flow meter, a pressure based flow meter, a variable area flow meter, an optical flow meter, a vortex flow meter, a sonar flow meter, an electromagnetic flow meter, an ultrasonic doppler flow meter, a coriolas flow meter, a laser doppler flow meter, or the like. The flow meter 14 comprises an entry port 40 and an exit port 42 and thus is configured to be insertable in-line with the conduit 26 proximate to the valve 12. The flow meter 14 is configured to detect the flow of the beverage passing through the conduit 26 and to generate a voltage signal.

Flow meters 14 are routinely incorporated into beverage dispensing assemblies that are commonly found in bars, taprooms, restaurants, sporting venues, and the like. The flow meters 14 can be positioned anywhere in the conduits 26 between the storage vessels 28 and the dispensing taps 30. A constraint of the present invention, in that the flow meter 14 also is acting as a Foam on Beer detector 44, is that the flow meter 14 should be positioned as closely as is possible to the storage vessel 28. The monitoring and control assembly 10 can seamlessly replace both the flow meters 14 and the Foam on Beer detectors 44 that have been incorporated into beverage dispensing assemblies.

The power supply unit 18 is operationally engaged to the controller 16, the valve 12, and the flow meter 14. The controller 16 is communicatively engaged to the valve 12 and the flow meter 14 so that the controller 16 is enabled to receive the voltage signal and to selectively actuate the valve 12. The controller 16 is programmed to integrate the voltage signal to determine a volume of the beverage flowing through the conduit 26. The controller 16 also is programmed with an algorithm to evaluate the voltage signal for a change in one or more of magnitude, stability, and frequency to determine if the beverage passing through the conduit 26 has changed between a liquid state and a foam state.

As in the prior art, the voltage signal can be integrated by the controller 16 to quantify the volume of the beverage that has flowed through the conduit 26. What is not anticipated in the prior art is utilization of the algorithm by the controller 16 to evaluate the voltage signal for a change indicative of the beverage changing from the liquid state to the foam state. For example, the voltage signal generated by the flow meter 14 is substantially stable when the beverage is in the liquid state. The voltage signal fluctuates rapidly when the beverage is in the foam state. This fluctuation, alone or in combination with other variables, can provide a basis for the controller 16 to actuate the valve 12 to prevent the conduit 26 from filling with the beverage in the foam state. As will be apparent to those skilled in the art of monitoring and control assemblies, the monitoring and control assembly 10 is intended for use with carbonated beverages, such as, but not limited to, beer, soda, and the like. Carbonated beverages should be interpreted, in the context of this disclosure, to include any liquid in which any gas is dissolved under pressure. For example, either carbon dioxide alone or as a mixture with nitrogen are used with beer.

The fluid line monitoring and control assembly 10 also may comprise a thermistor 46, which is configured to be insertable in-line with the conduit 26 so that the thermistor 46 is positioned adjacent to the flow meter 14. The thermistor 46 is configured to measure a temperature of the beverage passing through the flow meter 14 and to generate a potential difference signal. The algorithm enables the controller 16 to simultaneously evaluate the voltage signal for the change in the one or more of magnitude, stability, and frequency and the potential difference signal for a change in temperature. The change in temperature can be used to validate the change in the one or more of magnitude, stability, and frequency to mitigate false positive readings.

In one configuration of the fluid line monitoring and control assembly 10, the thermal mass flow meter 38 comprises a microelectromechanical system sensor 48 that is configured for thermopile sensing and allows for measurement of liquid flow rates of between 0.0 and 10.0 liters/minute. Fortuitously, the microelectromechanical system sensor 48 of a thermal mass flow meter 38 generally comprises a thermistor 46. A typical flow rate for beer in a beer line 32 is two ounces per second, which allows a pint of beer to be poured in eight seconds. This corresponds to a flow rate of 3.55 liters/minute. Parameters that vary between the liquid state and foam state of the beverage, and which influence the voltage reading, include, but are not limited to, density, viscosity, thermal conductivity, and specific heat. With foam flowing past the microelectromechanical system sensor 48, the voltage reading observed differs from that obtained for with liquid. Specifically, with beverage in the liquid state flowing past the microelectromechanical system sensor 48 at a rate of approximately 3.55 liters/minute, the voltage is substantially constant at approximately 3.3-3.6 volts, whereas with foam flowing past the microelectromechanical system sensor 48, the voltage reading fluctuates rapidly. This change in signal can be used as the basis for the controller 16 to actuate the valve 12. However, the voltage signal can fluctuate for other reasons, such as when opening and closing the dispensing tap 30. The algorithm thus must be capable of mitigating false positives.

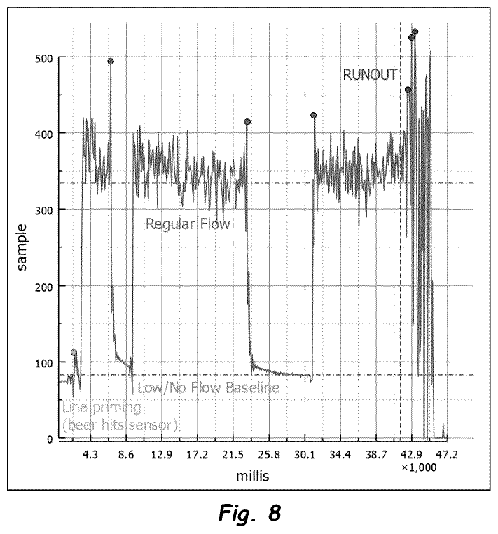

By way of specific example using a prototype fluid line monitoring and control assembly 10, a graph of voltage readings derived from dispensing beer from a 2.5 gallon keg 34 is shown in FIG. 8. Foam in the beer line 32 is detected using the algorithm applied to the three dotted peaks starting at timepoint 42.5 on the X axis in the voltage graph. Other dotted peaks in the graph at timepoints 6.7, 23.1, and 31.3 are ignored by the algorithm as they result from manipulation of the dispensing tap 30. It is worth noting that prior art devices would continue to integrate the voltage reading for a determination of volume. It is application of the algorithm by the controller 16 that enables detection of the foam whereupon the controller 16 actuates the valve 12 to close the beer line 32. For this experiment, the controller 16 was a generic Arduino board UNO R3 using an ATmega328P microcontroller (Microchip Technology, Chandler, AZ), the flow meter 38 was a model FS1025 (Renesas, Tokyo, Japan), and the valve 12 was a model BBQC-OS2-12VDC (EHCOTECH, San Diego, CA).

In the example above, the determination of foam required 0.805 seconds, which corresponds to 47.6 mL (1.61 oz) of foam passing the flow meter 38 prior to the valve 12 being actuated. As such, in this example foam occupies approximately 2.1 feet of the beer line 32 past the valve 12 as the dead space 94 between the valve 12 and the flow meter 38 is negligible. This minor intrusion of foam into the beer line 32 is minor relative to the overall length of the beer line 32, which can measure up to 200 ft. It is anticipated that this minor intrusion can be eliminated using a faster controller 16, an improved algorithm, or increased dead space 94, such as by separating the valve 12 from the flow meter 38 by 2.1 feet of looped beer line 32 or insertion of a 50 mL chamber between the valve 12 and the flow meter 38.

The controller 16 may be programmed to accept a purge command to actuate the valve 12 to an exhaust configuration, wherein the inlet port 22 of the valve 12 is open to the exhaust port 36. The valve 12 thus is configured to selectively bleed gas and foam in the conduit 26 between the valve 12 and a newly connected storage vessel 28 containing the beverage through the exhaust line 50. This allows a user to fill the conduit 26 between the storage vessel 28 and the valve 12 with, for example, beer, before the valve 12 is opened to the dispensing tap 30. The controller 16 may be programmed to accept a dispense command to actuate the valve 12 to a dispensing configuration, wherein the inlet port 22 of the valve 12 is open to the outlet port 24. Alternatively, the controller 16 may be programmed to actuate the valve 12 from the exhaust configuration to the dispensing configuration upon the flow meter 14 detecting the beverage in the liquid state.

The fluid line monitoring and control assembly 10 may comprise a flow control unit 52. The flow control unit 52 comprises a housing 54 that defines an interior space 56. The valve 12 and the flow meter 14 are coupled to the housing 54 and are positioned in the interior space 56. The flow meter 14 is fluidically engaged to the valve 12 within the housing 54. In one embodiment, as is shown in FIG. 2, the controller 16 also is coupled to the housing 54 and is positioned in the interior space 56. As discussed above, for each flow control unit 52 the valve 12 generally comprises a solenoid valve 20, which is three-way and generally closed, and the flow meter 14 comprises a thermal mass flow meter 38 that includes a thermistor 46. The housing 54 may be configured to be mountable to a surface, such as an interior wall of a cold room.

An inlet connector 58 is engaged to the housing 54 and extends from the entry port 40 of the flow meter 14. The inlet connector 58 configured to engage one of:
i. the conduit 26, so that the conduit 26 is in fluidic communication with the flow meter 14,
ii. an outlet 60 of the storage vessel 28 containing the beverage, so that the outlet 60 is in fluidic communication with the flow meter 14, or
iii. a probe 62 of a keg tap 64 engaged to the outlet 60, so that the probe 62 is in fluidic communication with the flow meter 14.

An outlet connector 66 is engaged to the housing 54 and extends from the outlet port 24 of the valve 12. The outlet connector 66 is configured to engage the conduit 26 so that the conduit 26 is in fluidic communication with the valve 12. The flow control unit 52 thus may be configured to be mountable to the outlet 60 of the storage vessel 28 or to a keg tap 64 engaged to the outlet 60. For example, the inlet connector 58 may comprise a threaded connector 68, as shown in FIG. 3, which is rotationally engaged to the housing 54 and which is compatible with a threaded end 70 of the probe 62 of the keg tap 64. In this configuration, a minimal volume of space is available between the keg 34 and the flow meter 14, thereby limiting space that can fill with foam. As shown in FIG. 3, the outlet connector 66 comprises a shank 72, such as, but not limited to, a G5/8 shank having threading identical to that of a probe 62, which is common to keg taps 64 used in the United States, allowing the flow control unit 52 to be readily inserted into an existing setup comprising a keg 34, a keg tap 64, and a beer line 32. The shank 72 allows the beer line 32 to be readily decoupled for line cleaning purposes.

The present invention also anticipates the valve 12 being engaged to the inlet connector 58 and the flow meter 14 being engaged to the outlet connector 66, as this would entail only a small increase in the space that can fill with foam.

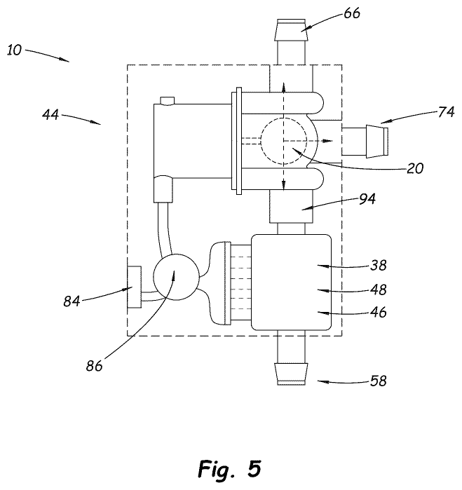

With the valve 12 being three-way, the valve 12 comprises the exhaust port 36. An exhaust connector 74 is engaged to the housing 54 and extends from the exhaust port 36 so that the valve 12 is configured to be selectively connectable to an exhaust line 50. Each of the inlet connector 58, the outlet connector 66, and the exhaust connector 74 may comprise a hose barb fitting 76, as shown in FIGS. 4 and 5, or other types of fitting, such as, but not limited to, push-to-connect fittings, threaded fittings, and the like.

In one configuration, as shown in FIG. 2 wherein the controller 16 is positioned in the housing 54, an indicator 78 and a switch 80 are engaged to the housing 54 and are operationally engaged to the controller 16. The controller 16 is enabled to actuate the indicator 78 concurrently with closing of the valve 12. The switch 80 is configured to be selectively switched to signal the controller 16 to deactuate the indicator 78 and to open the valve 12. This enables a user to see, via the indicator 78, that the valve 12 is closed and that the keg 34 needs to be changed. The user can install a full keg 34, use the switch 80 to open the inlet port 22 to the exhaust port 36 to fill the conduit 26 with beer, and then use the switch 80 to open the inlet port 22 to the outlet port 24 so that beer flows to the dispensing tap 30. In this configuration, the power supply unit 18 may comprise a power cord 82, which should be interpreted to mean that the controller 16 is powered by one or more batteries, a power cord 82, or a combination thereof. The present invention anticipates the power cord 82 being integral (permanently connected) to the housing 54 and the controller 16, or connectable by means of a connector (not shown). The present invention also anticipates the housing 54 having multiple connectors coupled thereto allowing for tethering of multiple fluid line monitoring and control assemblies 10.

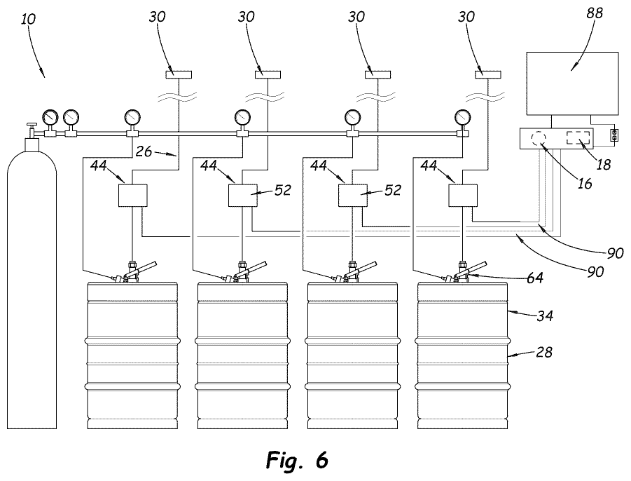

In another configuration, as is shown in FIG. 6, the flow control unit 52 is one of a plurality of flow control units 52, with each flow control unit 52 being operationally engaged in parallel to the controller 16. The power supply unit 18 is electrically engaged to each flow control unit 52 and to the controller 16. The power supply unit 18 may be integral to the controller 16, as is shown in FIG. 6. The controller 16 is enabled to receive the voltage signals and is programmed to integrate the voltage signals to determine the volumes of the beverages flowing through the conduits 26. The algorithm enables evaluation of each voltage signal for the change in the one or more of magnitude, stability, and frequency to determine if the beverage passing through a respective conduit 26 has changed between the liquid state and the foam state. In this configuration, each flow control unit 52 and the controller 16 may comprise a connection port 84 that allows use of parallel wiring 90 to enable powering of the flow control unit 52 by the power supply unit 18 and signaling between the controller 16 and the flow meters 14 and the valves 12.

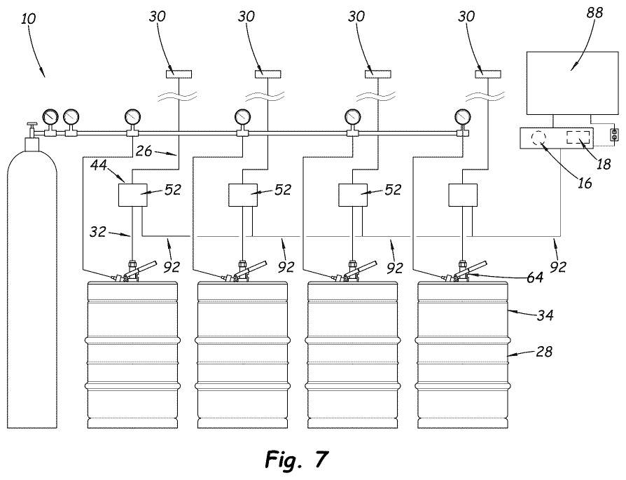

In yet another configuration, as is shown in FIG. 7, each flow control unit 52 is operationally engaged in series to the controller 16. In this embodiment, each flow control unit 52 comprises a signal processor 86. The signal processor 86 is operationally engaged to the flow meter 14, the valve 12, and the controller 16 so that the signal processor 86 is enabled to generate unit identifiable signals from the flow meter 14, to transmit the unit identifiable signals to the controller 16, and to receive unit specific commands from the controller 16 to selectively actuate the valve 12. The controller 16 in this embodiment is programmed for integrative processing of the unit identifiable signals from the signal processors 86 to determine volumes of the beverages flowing through each of the conduits 26 and to evaluate, for each flow control unit 52, the unit identifiable signal for the change in the one or more of magnitude, stability, and frequency, thereby enabling the controller 16 to determine if the beverage passing through the conduit 26 has changed between the liquid state and the foam state and to signal the requisite signal processor 86 to actuate the valve 12. In this configuration, each flow control unit 52 and the controller 16 may comprise a connection port 84 that allows use of serial wiring 92 to enable powering of the flow control unit 52 by the power supply unit 18 and signaling between the controller 16 and the signal processors 86.

In both the parallel and serial configurations, the fluid line monitoring and control 10 may comprise a display 88, which is operationally engaged to the controller 16 so that the controller 16 can selectively actuate the display 88. The controller 16 is programmed to track or determine one or more attributes of the valve 12, the flow meter 14, the beverage passing through the conduit 26, or the storage vessel 28, and to selectively actuate the display 88 to present the one or more attributes. Such attributes include, but are not limited to, positioning of the valve 12 (open, closed, exhaust), flow rate of the beverage through the conduit 26, state of the beverage in the conduit 26 (liquid, foam), temperature of the beverage in the conduit 26, volume of beverage dispensed from the storage vessel 28, and volume of beverage remaining in the storage vessel 28. The display 88 also may be touch enabled and allow for entry of commands into the controller 16, such as, but not limited to, the purge command, the dispense command, or the like.

In one example of use, the flow control unit 52 is attached to the threaded end 70 of the probe 62 using the threaded connector 68. The beer line 32 is attached to the outlet connector 66, positioning the solenoid valve 20 and the thermal mass flow meter 38 in-line with the beer line 32 as shown in FIG. XX. As beer flows through the thermal mass flow meter 38, a steady voltage reading is sent to the controller 16, which determines the volume of beer dispensed at the dispensing tap 30. When foam begins to pass through the thermal mass flow meter 38, a fluctuating voltage reading is communicated to the controller 16, whereupon the controller 16 actuates the solenoid valve 20 to stop beer in the foam state from flowing into the beer line 32 between the solenoid valve 20 and dispensing tap 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A fluid line monitoring and control assembly comprising:
a valve comprising an inlet port and an outlet port, wherein the valve is configured to be insertable in-line with a conduit connecting a storage vessel to a dispensing tap with the valve being positioned proximate to the storage vessel, wherein the valve is configured for selectively terminating flow of a beverage through the conduit;
a flow meter comprising an entry port and an exit port, wherein the flow meter is configured to be insertable in-line with the conduit proximate to the valve, wherein the flow meter is configured for detecting the flow of a beverage passing through the conduit and for generating a voltage signal;
a controller being communicatively engaged to the valve and the flow meter such that the controller is enabled for receiving the voltage signal, the controller being programmed for integrating the voltage signal to determine a volume of the beverage flowing through the conduit, the controller being programmed with an algorithm for evaluating the voltage signal for a change in one or more of magnitude, stability, and frequency to determine if the beverage passing through the conduit has changed between a liquid state and a foam state; a power supply unit
a power supply unit being operationally engaged to the controller, the valve, and the flow meter.

2. The fluid line monitoring and control assembly of claim 1, wherein:
the valve comprises a solenoid valve, a pneumatic valve, a hydraulic valve, an electric valve, or a spring valve; and
the flow meter comprises a thermal mass flow meter, a mechanical flow meter, a pressure based flow meter, a variable area flow meter, an optical flow meter, a vortex flow meter, a sonar flow meter, an electromagnetic flow meter, an ultrasonic doppler flow meter, a coriolas flow meter, or a laser doppler flow meter.

3. The fluid line monitoring and control assembly of claim 2, wherein the thermal mass flow meter comprises a microelectromechanical system sensor configured for thermopile sensing, the microelectromechanical system sensor being configured to measure liquid flow rates of between 0.0 and 10.0 liters/minute.

4. The fluid line monitoring and control assembly of claim 1, further comprising:
the valve comprising an exhaust port, wherein the valve is configured to be selectively connectable to an exhaust line; and
the controller being programmed to accept:
a purge command to actuate the valve to an exhaust configuration wherein the inlet port of the valve is open to the exhaust port, wherein the valve is configured for bleeding gas and foam in the conduit between the valve and a newly connected storage vessel containing the beverage through the exhaust line; and
a dispense command to actuate the valve to a dispensing configuration wherein the inlet port of the valve is open to the outlet port.

5. The fluid line monitoring and control assembly of claim 1, further comprising:
the valve comprising an exhaust port, wherein the valve is configured to be selectively connectable to an exhaust line;
the controller being programmed to accept a purge command to actuate the valve to an exhaust configuration wherein the inlet port of the valve is open to the exhaust port, wherein the valve is configured for bleeding gas and foam in the conduit between the valve and a newly connected storage vessel containing the beverage through the exhaust line; and
the controller being programmed to actuate the valve from the exhaust configuration to a dispensing configuration, wherein the inlet port of the valve is open to the outlet port, upon the flow meter detecting the beverage in the liquid state.

6. The fluid line monitoring and control assembly of claim 1, further comprising:
a thermistor configured to be insertable in-line with the conduit such that the thermistor is positioned adjacent to the flow meter, wherein the thermistor is configured for measuring a temperature of the beverage passing through the flow meter and for generating a potential difference signal; and
the algorithm enabling the controller for simultaneously evaluating the voltage signal for the change in the one or more of magnitude, stability, and frequency and the potential difference signal for a change in temperature to validate the change in the one or more of magnitude, stability, and frequency to mitigate false positive readings.

7. The fluid line monitoring and control assembly of claim 3, further comprising:
the microelectromechanical system sensor comprising a thermistor, wherein the thermistor is configured for measuring a temperature of the beverage passing through the flow meter and for generating a potential difference signal; and
the algorithm enabling the controller for simultaneously evaluating the voltage signal for the change in the one or more of magnitude, stability, and frequency and the potential difference signal for a change in temperature to validate the change in the one or more of magnitude, stability, and frequency to mitigate false positive readings.

8. The fluid line monitoring and control assembly of claim 1, further comprising a flow control unit, the flow control unit comprising:
a housing defining an interior space, the valve and the flow meter being coupled to the housing and positioned in the interior space, the flow meter being fluidically engaged to the valve within the housing;
an inlet connector being engaged to the housing, extending from the entry port of the flow meter, and configured for engaging one of:
the conduit, such that the conduit is in fluidic communication with the flow meter;
an outlet of the storage vessel containing the beverage, such that the outlet is in fluidic communication with the flow meter; and
a probe of a keg tap engaged to the outlet, such that the probe is in fluidic communication with the flow meter; and
an outlet connector engaged to the housing and extending from the outlet port of the valve, wherein the outlet connector is configured for engaging the conduit such that the conduit is in fluidic communication with the valve.

9. The fluid line monitoring and control assembly of claim 8, further comprising the controller being coupled to the housing and positioned in the interior space.

10. The fluid line monitoring and control assembly of claim 8, further comprising:
the flow control unit being one of a plurality of flow control units, each flow control unit being operationally engaged in parallel to the controller;
a power supply unit being electrically engaged to each flow control unit of the plurality of flow control units and to the controller; and
the controller being enabled for receiving the voltage signals and being programmed for integrating the voltage signals to determine the volumes of the beverages flowing through the conduits, the algorithm enabling evaluation of each voltage signal for a change in one or more of magnitude, stability, and frequency to determine if the beverage passing through a respective conduit has changed between a liquid state and a foam state.

11. The fluid line monitoring and control assembly of claim 8, further comprising:
the flow control unit being one of a plurality of flow control units, each flow control unit being operationally engaged in series to the controller, each flow control unit comprising a signal processor, the signal processor being operationally engaged to the flow meter, the valve, and the controller such that the signal processor is enabled for generating unit identifiable signals from the flow meter, for transmitting the unit identifiable signals to the controller, and for receiving unit specific commands from the controller to selectively actuate the valve;
a power supply unit being electrically engaged to the plurality of flow control units and to the controller; and
the controller being programmed for integrative processing of the unit identifiable signals from the signal processors to determine volumes of the beverages flowing through each of the conduits and for evaluating, for each flow control unit, the unit identifiable signal for the change in the one or more of magnitude, stability, and frequency, enabling the controller to determine if the beverages passing through the conduits have changed between a liquid state and a foam state and signaling the signal processor to actuate the valve.

12. The fluid line monitoring and control assembly of claim 10, further comprising the power supply unit being integral to the controller.

13. The fluid line monitoring and control assembly of claim 11, further comprising the power supply unit being integral to the controller.

14. The fluid line monitoring and control assembly of claim 8, further including:
an indicator engaged to the housing and being operationally engaged to the controller, positioning the controller for actuating the indicator concurrently with closing of the valve; and
a switch engaged to the housing and operationally engaged to the controller, wherein the switch is configured for being selectively switched to signal the controller to deactuate the indicator and to open the valve.

15. The fluid line monitoring and control assembly of claim 8, wherein the inlet connector comprises a threaded connector, the threaded connector being complementary to the probe of the keg tap; and
the outlet connector comprising a shank, the shank being threaded as is the probe.

16. The fluid line monitoring and control assembly of claim 8, wherein:
the valve comprises a solenoid valve, a pneumatic valve, a hydraulic valve, an electric valve, or a spring valve; and
the flow meter comprises a thermal mass flow meter, the thermal mass flow meter comprising a microelectromechanical system sensor configured for thermopile sensing, the microelectromechanical system sensor being configured to measure liquid flow rates of between 0.0 and 10.0 liters/minute.

17. The fluid line monitoring and control assembly of claim 16, further comprising:
the microelectromechanical system sensor comprising a thermistor, wherein the thermistor is configured for measuring a temperature of the beverage passing through the flow meter and for generating a potential difference signal; and
the algorithm enabling the controller for simultaneously evaluating the voltage signal for the change in the one or more of magnitude, stability, and frequency and the potential difference signal for a change in temperature to validate the change in the one or more of magnitude, stability, and frequency to mitigate false positive readings.

18. The fluid line monitoring and control assembly of claim 8, further comprising:
the valve comprising an exhaust port;
an exhaust connector engaged to the housing and extending from the exhaust port, wherein the valve is configured to be selectively connectable to an exhaust line; and
the controller being programmed to accept:
a purge command to actuate the valve to an exhaust configuration wherein the inlet port of the valve is open to the exhaust port, wherein the valve is configured for bleeding gas and foam in the conduit between the valve and a newly connected storage vessel containing the beverage through the exhaust line; and
a dispense command to actuate the valve to a dispensing configuration wherein the inlet port of the valve is open to the outlet port.

19. The fluid line monitoring and control assembly of claim 8, further comprising:
a display being operationally engaged to the controller such that the controller is enabled for selectively actuating the display; and
the controller being programmed to track or determine one or attributes of the valve, the flow meter, the beverage passing through the conduit, or the storage vessel and to selectively actuate the display to present the attribute.
